(19) United States
(12) Patent Application Publication
(10) Pub. No.: US 2005/0068462 A1
(43) Pub. Date: Mar. 31, 2005

(54) Process for associating and delivering data with visual media

(76) Inventors: Helen J. Harris, Woodland Hills, CA (US); Robert S. Harris, Woodland Hills, CA (US)

Correspondence Address: Aaron T. Borrowman;Kelly Lowry & Kelley, LLP, Suite 1650, 6320 Canoga Avenue, Woodland Hills, CA, 91367, US

(21) Appl. No.: 10/913,308

(22) Filed: Aug. 5, 2004

Related U.S. Application Data
(63) Continuation-in-part of application No. 09/921,958, filed on Aug. 2, 2001.
(60) Provisional application No. 60/224,459, filed on Aug. 10, 2000.

(51) Int. Cl. H04N 7/084

(52) U.S. Cl. 348/473; 348/62

(57) ABSTRACT

A process for associating and delivering data with a video signal includes digitizing an analog data signal. The digitized data is then compressed and transcoded into a format compatible with a video source signal. The data is then inserted into unused video lines of the video source signal outside the vertical and horizontal blanking internet. The encoded video source signal is transmitted to a decoder where the inserted data is separated from the video source signal. The inserted data is then converted to its original form, and either visually displayed or audibly delivered to an end user. The invention can be used to associate and deliver audio narrative description with a video signal for the benefit of the visually impaired.

### RELATED APPLICATION

This application is a continuation-in-part of U.S. application Ser. No. 09/921,958, filed Aug. 2, 2001, which claims priority from provisional application Ser. No. 60/224,459 filed Aug. 10, 2000.

### BACKGROUND OF THE INVENTION

The present invention generally relates to distributing broadband content and data. More particularly, the present invention relates to a process for associating and delivering data with visual media, and has particular application to associating audio and description narration with visual media for the benefit of the severely visually impaired.

According to United States census data, thirty-one million people in the United States are unable to completely enjoy movies or television because of severe visual impairment. Although the visually impaired can listen to the dialog between the various actors, as well as sound effects and music, they are unable to ascertain aspects of the film which are not spoken such as the background setting, character dress, relational placement of the characters, and unspoken action. It is estimated that the average movie contains forty-five minutes of unspoken action. Thus, a visually impaired person is literally left in the dark as to what is happening during the movie during these forty-five minutes.

Recently, the Federal Communications Commission has mandated television and cable networks begin offering “audio description” which would describe the unspoken action and other necessary narrative elements. According to the mandate, the television and cable producers must do so through the secondary language (SAP) channels on televisions. However, the vast majority of television and cable stations are not currently equipped with SAP systems. This will require an enormous financial investment on the television and cable producers part to obtain the appropriate SAP analog equipment. Furthermore, such SAP systems require appropriate engineering, constant maintenance by qualified video engineers, and enormous storage space as the equipment must be air conditioned. Such equipment will become obsolete in a few years when the television and cable industry completely converts to digital. The cable industry association estimates that small cable companies alone will have to spend over 20 million dollars, and the entire industry close to 1 billion dollars to comply with the FCC ruling.

Different methods of transmission have been used for inserting content data containing additional information into the video signals of various broadcasting formats. Including, for example National Television System Committee (NTSC), Digital Advanced Television Systems Committee (ATSC), Sequentiel Couleur a Memorie SECAM, or Phase Alternation Line (PAL) compliant broadcasting formats. Both the active or viewable and blank portions have been used, that is the horizontal and blanking intervals of a video signal. Different modifications to the luminance and chrominance carriers have been exploited, such as teletex where textual information is substituted for a video portion of the signal and the active portion of the video signal so as to be viewed by the television viewer. To date, however, the portion between the active and blank portions of the video signal have not been utilized. This is due to the fact that this portion is typically covered by a television's plastic box or mask so that it is typically not viewable by residential viewers, and inserting non-video signal, such as modulated voltage signal, etc., such as that used for closed captioning and the like can actually interfere with the active video source signal and distort the picture and create other compatibility problems.

Accordingly, there is a need for a process for associating audio description within visual media, such as television and cable programming, which does not require television and cable stations to acquire SAP systems and equipment. What is further needed is a process for associating encoded audio description within the visual media so that only those wishing to listen to the audio description can do so selectively. Such coded audio description should not interfere with the presentation of the visual media. The present invention fulfills these needs and provides other related advantages.

### SUMMARY OF THE INVENTION

The present invention resides in a process for associating and delivering data with a video signal. The general steps of the process comprise first encoding a video source signal by inserting data in unused video bandwidth of the video source signal. The encoded video source signal is then transmitted to its destination, where it is decoded. The data is separated during the decoding process and either visually displayed or audibly delivered to an end user.

The encoding step includes the step of digitizing an analog data signal. Typically, the analog signal comprises an audio signal. In a particularly preferred form of the invention, the audio signal comprises an audio narrative description of visual media associated with the video source signal for the benefit of the visually impaired. The digitized data is then compressed and transcoded for insertion into predetermined unused video lines of the video source signal, typically between the active viewable and blanking portions.

The decoding step includes the steps of decompressing the inserted data after it is separated from the video source signal. The decompressed data is then converted from a digital format into an analog signal. When the analog signal comprises an audio signal, this signal is delivered to audio speakers, such as a headset worn by a visually impaired person.

As the data is associated with the video signal so as not to interrupt the transmission and reception of the video signal, the unused bandwidth of the video signal can be advantageously used to convey additional information. This may include a narrative description of the visual media so that a visually impaired person can be informed of the background setting, character dress, relational placement of the characters, and unspoken action of the visual media. This narrative description could also comprise on-screen visual messages, such as television program guides, and the emergency broadcast system visual messages. Of course, the invention is not limited to these uses, but can have other applications in which data can be advantageously associated with a video signal in a transparent fashion.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a flowchart illustrating the steps of encoding a video source signal in accordance with the present invention;

FIG. 2 is a flowchart illustrating the steps taken in decoding the video source to remove the inserted data for delivery in accordance with the present invention;

FIG. 3 is a representation of a video screen, illustrating lines of visible video, and lines which are reserved or unused and not typically viewed;

FIG. 4 is a schematic block diagram illustrating the process of encoding an original video master in accordance with the present invention;

FIG. 5 is a schematic block diagram illustrating the process of decoding the video master and separating the video signal and inserted audio data in accordance with the present invention;

FIG. 6 is a schematic block diagram illustrating the general process of encoding an original video master with an audio narrative description for the benefit of the visually impaired in accordance with the present invention; and

FIG. 7 is a schematic block diagram illustrating the process of encoding the original video master of FIG. 6.

### DETAILED DESCRIPTION OF THE PREFERRED EMBODIMENTS

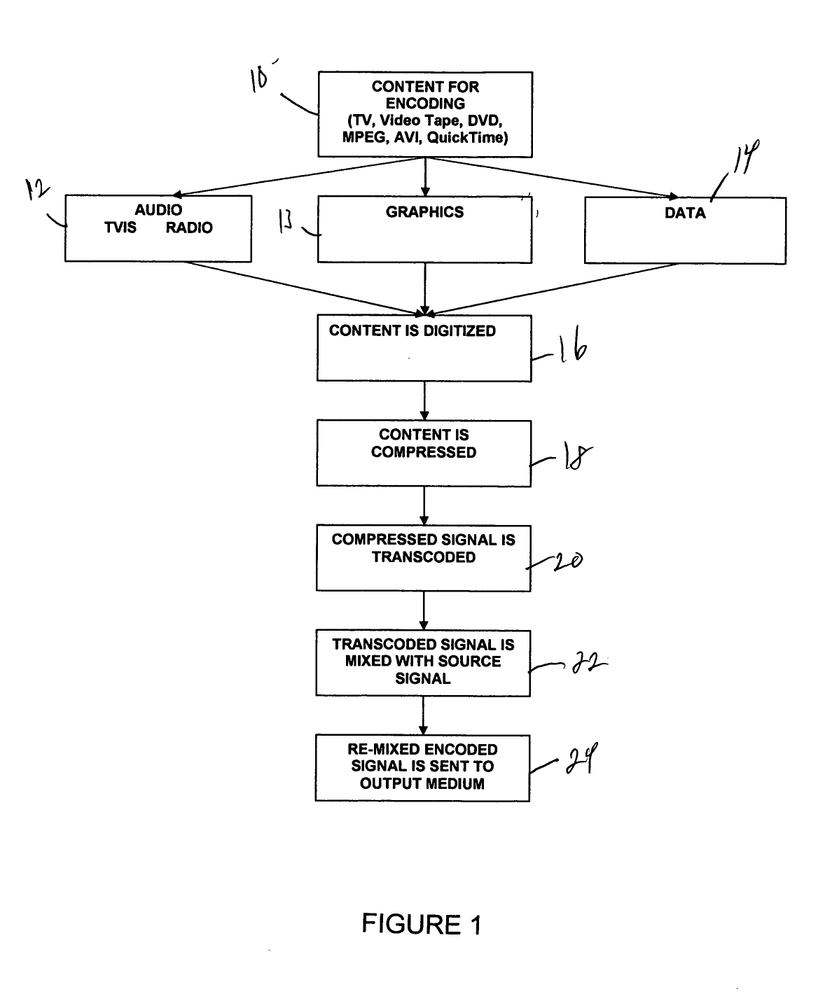

As illustrated in the accompanied drawings for purposes of illustration, the present invention is concerned with a process for associating and delivering data with a video signal. With reference to FIG. 1, data content to be inserted into a video signal (10), which may comprise either an audio signal (12) or TVIS or radio signals, graphics or other data (13 and 14) or a combination thereof is provided. This content is typically in an analog signal format originally. In order to be associated and delivered with the video signal, the content is digitized (16). The digitized content is then compressed (18) and the compressed signal is transcoded (20). The compressed and transcoded data content signal is then mixed with the video source signal (22), which is sent to the output medium (24), such as a video tape, DVD, MPEG file, digital tape, etc. The foregoing steps illustrated in FIG. 1 are collectively referred to as the step of encoding the video source signal with the data content.

The encoded video source signal is then transmitted to the end user, such as by transmitting through an Internet connection, playing a video tape in a VCR, a DVD in a DVD player, or by cable or television transmission or the like. Due to the formatting of the data content, it essentially becomes one with the video source signal so as to be effectively transparent to all existing broadcast systems, equipment, players, etc.

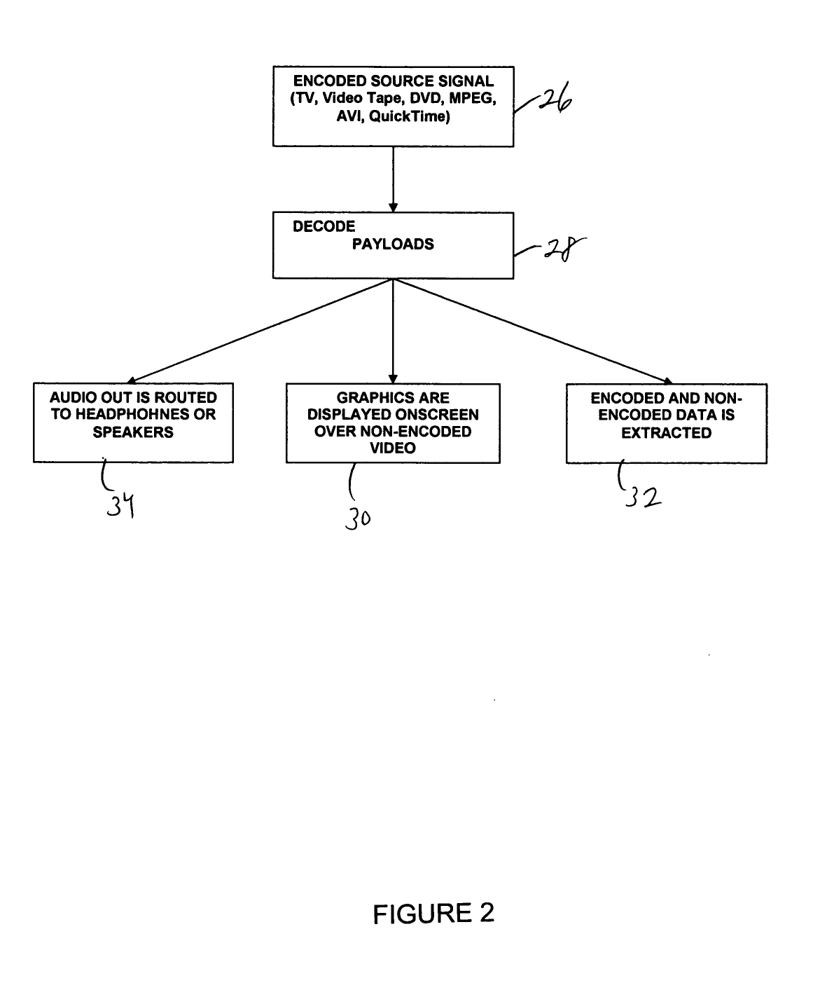

With reference now to FIG. 2, the mixed and encoded source signal (26) passes through a decoding circuitry where it is decoded (28). The encoded and non-encoded data is extracted (32) and the graphics are displayed onscreen over the non-encoded video (30) or the audio output is routed to headphones or speakers (34).

It has been found that broadband content signals, particularly video signals such as television signals, have unused bandwidth, lines or holes which can be advantageously used to transmit data, particularly outside of the blanking portion. So long as the unused bandwidth can be determined and found, and the data content to be distributed formatted appropriately to be fit within the unused bandwidth, simultaneous transmission is possible. The invention can have applicability to Internet, videos and graphics, distribution of information across wireless networks, information conveyed to personal digital assistance and other hand-held electronic devices, etc. The present invention is particularly adapted to be used on video input to televisions, and television broadcasts.

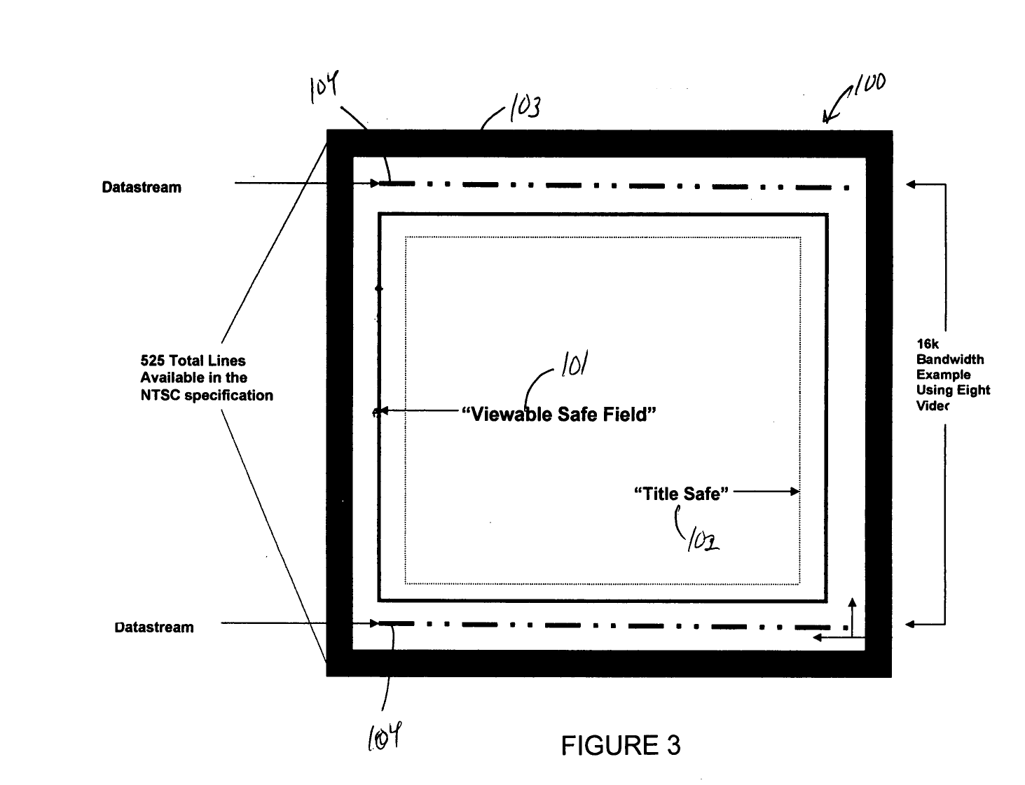

With reference to FIG. 3, a representative diagram of a television screen (100) is shown. According to the NTSC SMPTE specification, there are a total of 525 video lines available for use. However, on the program area is only 720×486 or 720×480 depending on whether the format uses square or non-square pixels, the similar active field is also used for transporting ATSC or broadband formats. The television industry is able to use the lines of video in the viewable space field 101, although television standards and practices adhere to the areas of “safe title” or “safe picture” 102 which amounts to the about 90% of the total picture area, and can be referred to as the “safe action”. A gap exists between the “viewable safe field” and the horizontal and vertical blanking intervals 103, often referred to as the “blanking” portions. This “blanking” portion typically has data inserted into, such as closed captioning and other signals. It is the “unused” lines of video 104 between the active viewable safe field 101 and the “blanking” lines 103 which is targeted by the present invention. This area 104 is not visible on a typical television set or monitor because of the plastic box or mask which all televisions and monitors use, covering the outer edge beyond the picture contained within the “title safe” 102 or “viewable safe field” 101. These lines are typically not viewed on a television set due to the extension of the frame of the television box over these unused lines. Different formats, such as PAL used in Europe, similarly have unused or reserved video lines of unused bandwidth. The present invention utilizes these unused lines or bandwidth to its advantage in order to associate and deliver data content which might otherwise be incompatible, or unrelated to the video signal transmission. The invention does this in a manner which renders the associated and inserted data invisible or transparent to existing broadcast systems and equipment so that an end user desiring to extract the inserted data content need only have a decoder. Those not having a decoder would not be aware that additional information is contained within the unused bandwidth as it is not viewable and passed through all equipment in a transparent fashion.

In order that the data be invisible or transparent to existing broadcast systems and equipment while residing in the unused bandwidth between the “active” and “blank” portions of the video signal, the present invention employs a novel transcoding methodology. That is the source data/audio file is transcoded from its original format (analog or digital signals, such as voltage signals) to color values. Specific standards for both television and broadband standards have been established by SMPTE and ICU, which define the number and range of colors within each specification, pixel shape, etc., as follows:

| lines | horizontal sampling | Governing specification | Abbrev. |
|---|---|---|---|
| 525-line | square-pixel | ANSI/SMPTE 170M-1994 | NTSC |
| | (NTSC) | | |
| | non-square-pixel | ANSI/SMPTE 125M, 259M | 525-dig |
| | (Rec. 601 Digital) | ITU-R BT.601-4 | |
| 625-line | square-pixel | ITU-R BT.470-3 | PAL |
| | (PAL) | (B, G, H, I, D, K, K1, L-PAL) | |
| | non-square-pixel | ITU-R BT.656-2 | 625-dig |
| | (Rec. 601 Digital) | ITU-R BT.601-4 | |

Data/audio now represented RGBNGA or former CCIR-601 colors is now comprised of individual pixels, each pixel or group of pixels can contain predetermined “patterns” which are comprised of both varying color and pixel positions which form distinct patterns. The color/pixel patterns are capable of representing data extremely efficiently due to the exponential nature of potential values each pixel block(s) may contain.

Patterns may be formed within individual lines of video or in combination with adjacent lines to provide for more robust pixel patterns, increasing signal integrity in noisy environments. The net result is a line or lines of video, which look very similar to a Rubik's Cube™. The size and density of pixel patterns become increasingly more fault tolerant as the pattern size and pixel blocks increase in size. Larger patterns also negate the need for error correction, further reducing overhead. As the data for each frame is embedded within the frame, re-synchronization is also unnecessary.

This unique pattern of transcoding is easily passed through both television and broadband systems with the added benefit of reducing actual bandwidth. Since the native signal normally found on lines of video is color values, this system remains passive to industry standard techniques for editing, amplification, distribution and eventual reception by the end user.

The data which has now been encoded and transcoded and represented as RGB or VGA colors is targeted for encoding into the unused picture area between “safe visible field” and the limits of the “active” field bordering on the “blanking” portion, comprising the horizontal and vertical blanking.

In the NTSC example, 720×486 lines contain active picture but substantially less than that is visible on a consumers television. This area is not visible on the television because of the mask which all televisions and monitors use. Thus, only about 90% of the total picture area is used, which is symmetrically located inside of the picture border. Residential television sets are overscanned, the viewer not being able to see the entire picture as the edges are lost beyond the border of the screen. “Safe action” area is designated as the area of the picture that is “safe” to put action that the viewer needs to see.

The following tables provide reference standards for determining pixel properties, shape, bit value, color space and bandwidth for the respective standards:

Video Conventions for NTSC and PAL Examples:

| Lines | horizontal sampling | Governing specification | Abbrev. |
|---|---|---|---|
| 525-line | square-pixel | ANSI/SMPTE 170M-1994 | NTSC |
| | (NTSC) | | |
| | non-square-pixel | ANSI/SMPTE 125M, 259M | 525-dig |
| | (Rec. 601 Digital) | ITU-R BT.601-4 | |
| 625-line | square-pixel | ITU-R BT.470-3 | PAL |
| | (PAL) | (B, G, H, I, D, K, K1, L-PAL) | |
| | non-square-pixel | ITU-R BT.656-2 | 625-dig |
| | (Rec. 601 Digital) | ITU-R BT.601-4 | |

By Video Standard:

| | | field/ | x | y | total |
|---|---|---|---|---|---|
| format | part | frame | size | size | pixels |
| NTSC | active | frame | 646 | 486 | 313956 |
| NTSC | active | field | 646 | 243 | 156978 |
| 525-dig | active | frame | 720 | 486 | 349920 |
| 525-dig | active | field | 720 | 243 | 174960 |
| 525-dig | full- | frame | 858 | 525 | 450450 |
| | raster | | | | |
| 525-dig | full- | field | 858 | 262.5 | 225225 |
| | raster | | | | |
| PAL | active | frame | 768 | 576 | 442368 |
| PAL | active | field | 768 | 288 | 221184 |
| 625-dig | active | frame | 720 | 576 | 414720 |
| 625-dig | active | field | 720 | 288 | 207360 |
| 625-dig | full- | frame | 864 | 625 | 540000 |
| | raster | | | | |
| 625-dig | full- | field | 864 | 312.5 | 270000 |
| | raster | | | | |

Broadcast Standard Play Rates:

| | frames/ | ms/ | fields/ | ms/ |
|---|---|---|---|---|
| format | second | frame | sec | field |
| NTSC and | 29.97 | 33.3667 ms | 59.9401 | 16.6833 ms |
| 525-dig | | | | |
| PAL and | 25 | 40 ms | 50 | 20 ms |
| 625-dig | | | | |

Bytes Per Field/Frame:

| | | | bytes | | |
|---|---|---|---|---|---|
| | | field/ | per | total | |
| format | part | frame | pixel | bytes | |
| 623-dig | full- | frame | 4 | 2109.375 | kb |
| | raster | | | | |
| 525-dig | full- | frame | 4 | 1759.570 | kb |
| | raster | | | | |
| PAL | active | frame | 4 | 1728.000 | kb |
| 625-dig | active | frame | 4 | 1620.000 | kb |
| 525-dig | active | frame | 4 | 1366.875 | kb |
| NTSC | active | frame | 4 | 1226.391 | kb |
| 625-dig | full- | frame | 2 | 1054.688 | kb |
| | raster | | | | |
| 625-dig | full- | field | 4 | 1054.688 | kb |
| | raster | | | | |
| 525-dig | full- | frame | 2 | 879.785 | kb |
| | raster | | | | |
| 525-dig | full- | field | 4 | 879.785 | kb |
| | raster | | | | |
| PAL | active | frame | 2 | 864.000 | kb |
| PAL | active | field | 4 | 864.000 | kb |
| 625-dig | active | frame | 2 | 810.000 | kb |
| 625-dig | active | field | 4 | 810.000 | kb |
| 525-dig | active | frame | 2 | 683.438 | kb |
| 525-dig | active | field | 4 | 683.438 | kb |
| NTSC | active | frame | 2 | 613.195 | kb |
| NTSC | active | field | 4 | 613.195 | kb |
| 625-dig | full- | field | 2 | 527.344 | kb |
| | raster | | | | |
| 525-dig | full- | field | 2 | 439.893 | kb |
| | raster | | | | |
| PAL | active | field | 2 | 432.000 | kb |
| 625-dig | active | field | 2 | 405.000 | kb |
| 525-dig | active | field | 2 | 341.719 | kb |
| NTSC | active | field | 2 | 306.598 | kb |

Data Rate For Full Bandwidth Video:

| | | bytes | total bytes per |
|---|---|---|---|
| format | part | per pixel | second |
| 625-dig | full- | 4 | 51.498 Mb/sec |
| | raster | | |
| 525-dig | full- | 4 | 51.498 Mb/sec |
| | raster | | |
| PAL | active | 4 | 42.188 Mb/sec |
| 525-dig | active | 4 | 40.005 Mb/sec |
| 625-dig | active | 4 | 39.551 Mb/sec |
| NTSC | active | 4 | 35.894 Mb/sec |
| 625-dig | full- | 2 | 25.749 Mb/sec |
| | raster | | |
| 525-dig | full- | 2 | 25.749 Mb/sec |
| | raster | | |
| PAL | active | 2 | 21.094 Mb/sec |
| 525-dig | active | 2 | 20.003 Mb/sec |
| 625-dig | active | 2 | 19.775 Mb/sec |
| NTSC | active | 2 | 17.947 Mb/sec |

As discussed above, the vertical and horizontal blanking intervals, and areas designated by the SCC and SMPTE for the exclusive use of timing, synchronization or other regulated and required signals are not targeted or used for the transcoded signals. Such areas are referred to herein as “used” bandwidth or video lines. The transport area that the present invention utilizes includes the program 720×486 or 720×480, depending on whether the format uses square or non-square pixels, the similar active field also being used for transporting ATSC or broadband formats. Smaller unused areas, such as the lines outside safe picture would be targeted for broadcast television. In the event that the present invention were able to be implemented into a television channel which would not require a picture in the “viewable state field”, such as a channel dedicated exclusively to the blind, the entire programmable area could be targeted and considered unused bandwidth. This would enable up to 240 simultaneous radio stations on a single, unused television channel, thus enabling greater radio programming accessibility to the blind and visually impaired.

“Source” signals, once embedded within the video signal, are not compressed or modulated or manipulated in an analog technique. Nor are they transported as anything other than SMPTE or NTSC approved color values and VGA values for the Internet. They are “transcoded”, as discussed above, each audio value represented as a color value. The specific colors, shapes formed by the color patterns determine their numeric value allowing the information to exist as a numeric value, not a modulated, multiplexed or voltage-based signal.

The “transcoding” in this fashion and within these areas of the “source” signal are the only possible way to not increase signal bandwidth, interfere or compete with other existing or competing signals from other commercial entities and be cross platform compatible.

Signals originally encoded for NTSC for example are easily retained if that signal is converted to a streaming format, or thereby retaining the audio description or accessibility data stream for the individual regardless of whether they choose to view a program on television or the Internet.

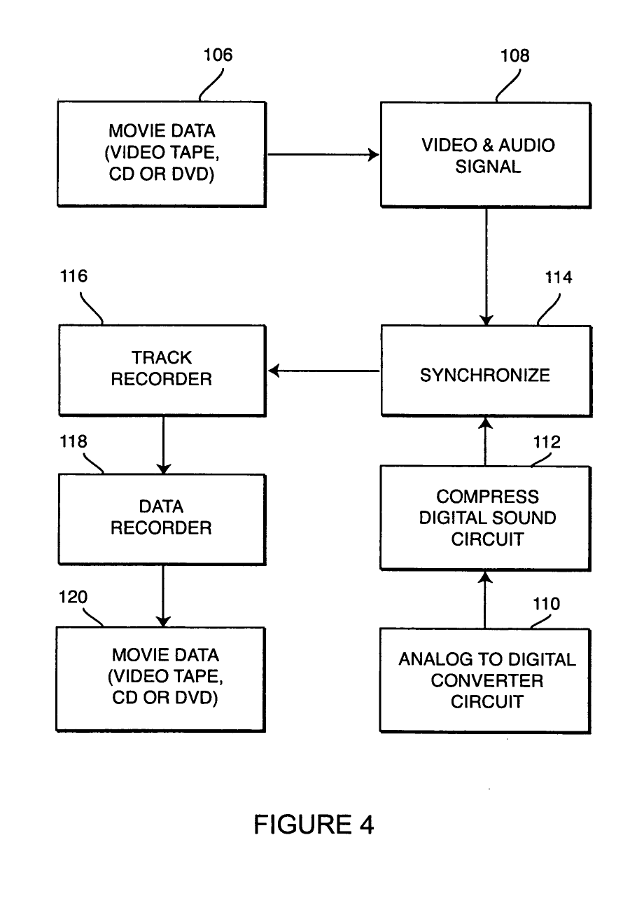

With reference now to FIG. 4, a schematic diagram of a recorder for a television application is illustrated. An original master videotape, CD, or DVD, or like is played in a system (106) where the video and audio signals (108) are separated. The audio or data content in analog signal is converted to digital (110) by appropriate circuitry. This digital signal is compressed (112) and then synchronized (114) or interleaved with the video signal. This mixed and synchronized video signal having the data content inserted therein is re-recorded at track recorder (116) to overlay the original audio signal. This is recorded (118) on a new master (120) video tape, CD, or DVD.

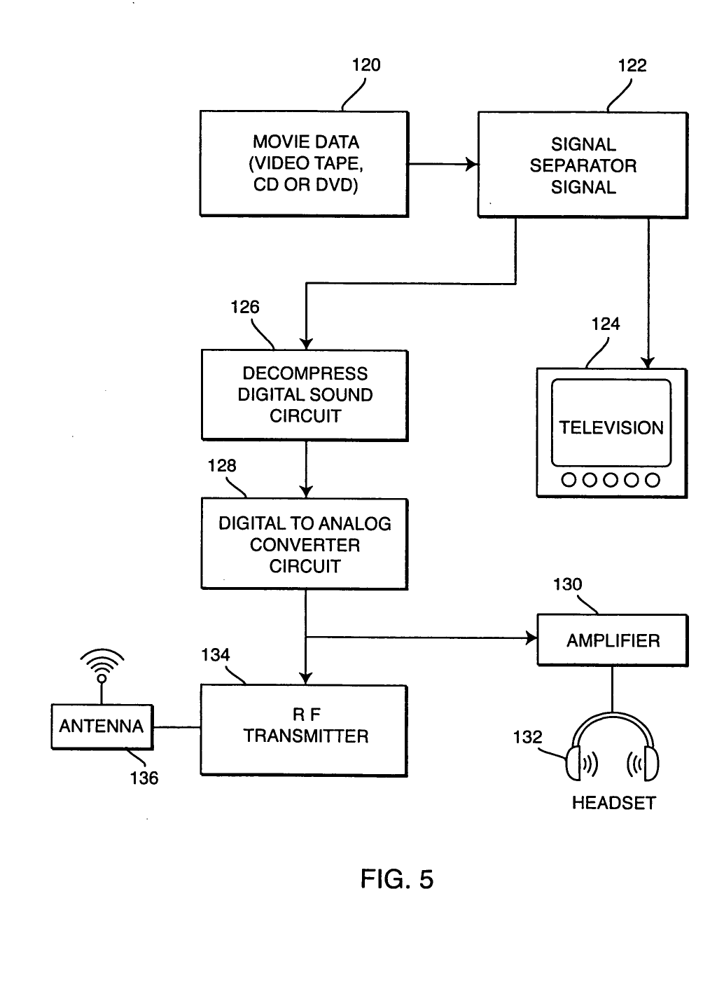

Referring now to FIG. 5, the new master (120) is transmitted via cable, television broadcast, or played in the appropriate player, such as a VCR tape player, DVD player, or the like. A decoder, in the form of a set-top box, or electronic circuitry built into the television or player system includes a signal separator circuit (122), such as a de-interleaver, that extracts the inserted data content from the movie signal which is sent to the display device such as a T.V. (124). The extracted data content is then decompressed (126) using appropriate circuitry, after which it is converted back into its original analog signal format (128). At this point, the analog signal can be sent to an amplifier (130) for transmission to an audio speaker (132) or headset directly connected to the amplifier via a-jack or the like. Alternatively, the analog signal can be transmitted to a radio frequency transmitter (134) or transmission to an antenna (136) for wireless speakers, or a wireless headset. The systems shown in FIGS. 4 and 5 assume that the inserted data content comprises an audio signal. However, it is to be understood that the invention is not limited to such, and can include graphics which are overlaid on the television or monitor or the visual medium of the video source signal. Such graphics could also be separated and sent to a separate monitor or television set.

The process of the present invention allows “audio description narration” of a visual media to be encoded permanently onto the show picture master, thereby locking forever, regardless of whether the picture is copied, edited, or rebroadcast. Such audio descriptions are prepared prior to creation of the show picture master. Such audio descriptions will incorporate a narrative of unspoken action, or other necessary background information, which is seen but not heard in the visual media. Such visual media can include film, movies, television programming, and the like.

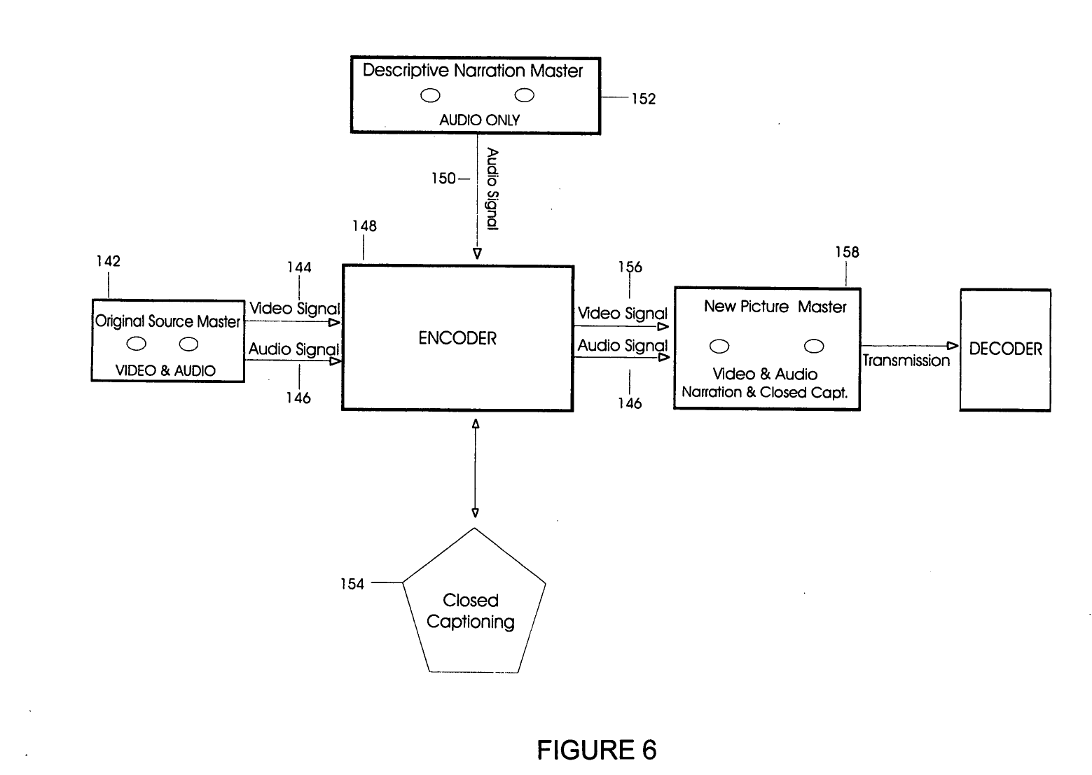

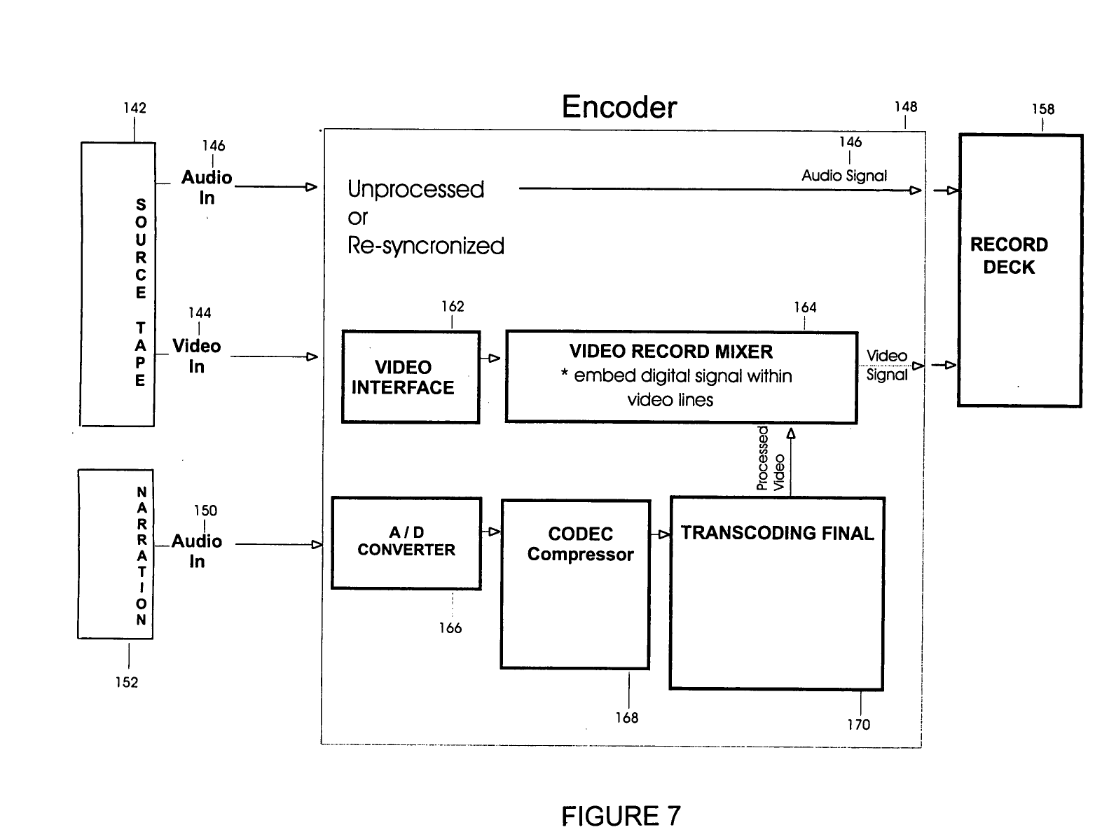

Referring to FIGS. 6 and 7, the original source master (142) includes both original video and audio signals (144) and (146). The video signal (144) is fed into and encoder (148) where it is processed, typically at a CCIR 601 level. Simultaneously, the audio signal (146) is fed into the encoder (148) in an unprocessed manner. A signal (150) from an audio description narration master (152) is also fed into the encoder (148). A closed captioning signal (154) may also be fed into the encoder (148) so that a new video signal (156) including the original video source signal (144), the inserted data from the description narration audio signal (150), as well as the closed captioning signal (154) is produced and saved on a new picture master (158). The original audio signal (146) is overlaid, and if necessary, re-synchronized, with the mixed and encoded video signal (156).

The encoder (148) is designed to accept both video and audio inputs for processing. The encoder (148) can function both as a dedicated hardware device or software application within editing system modified for non-linear video editing, such as AVID, Adobe Premier, After Effects, Final Cut Professional, and the like. The video source inputs can include composite, component, serial digital, DVD, MPEG, and all streaming formats. The audio source inputs can include composite, digital, analog XLR balanced and unbalanced SPDIF (Sony Phillips Digital) and streaming.

The encoding process takes a narrative audio sample of approximately 8 KHZ in bandwidth and converts that analog signal into a digital data stream. The data is further encoded and recorded to fit onto a single unused line of NTSC or PAL video.

Referring now to FIG. 7, a more detailed schematic illustration of the encoder (148) is shown. As stated above, the audio signal from the source tape (146) is fed into the encoder (148) where it typically is simply passed through unprocessed so as to remain 1 volt peak to peak, or re-synchronized if necessary to the record deck (160) where it is overlaid with the mixed video signal (156).

The video signal (144) from the source tape is fed into the encoder (148) through a video interface (162), where it may be necessarily decoded, before being fed into a video record mixer (164). Simultaneously, the audio signal (150) from the narration master (152) is fed into the encoder (148) so that the audio analog signal is converted to a digital stream by A/D converter (166). A code receives the digital audio signal and processes it to remove unnecessary data in order to compress and reduce the size of the digital file. Several companies have specific codes for 8K audio such as Qualcomm, Motorola, Quicktime and MP3, and RealPlayer. The remaining compressed digital audio file is sent to a transcoder (170) which inserts edit in the video record mixer (164) on a single line of video. The transcoder translates the language of the incoming signal into the language of the target signal or medium. This involves synchronizing and conforming voltages, bandwidth, bit rate, etc. so that the processed signal (172) is compatible with the video signal (144) Depending upon whether the signal is to be produced in the United States or abroad, the single line of video is inserted as NTSC or PAL. The narrated audio file is compressed to fit in a 32 KB band width in order to fit within a single line of the unused bandwidth. The digital transcoded narrative audio signal (172) is inserted into one of these lines of video which do not interfere with the appearance of the broadcasted visual media, but rather are hid, for example, within the boxed portion of a television set. Furthermore, these lines of video are transparent to the broadcaster equipment.

The video record mixer (164) combines the video signal (144) with the transcoded signal of the narration (172) and sends this signal (156) to the record deck (160). The video signal (144) that came from the original master (142) now has a single line of video digital audio recorded on a chosen line and is recorded along with unprocessed audio (146) from the original master for recording on a tape or digi-beta tape which becomes a new picture master (158). Closed captioning (154) can interface with the encoder (148) to allow the dual encoding of both the closed captioning and narrated audio into the video signal (144) at the video record mixer (164) so that the closed captioning (154) is included on the new picture master (158). The closed captioning (154) is digitally set for a different line than the narrated audio (150), but both can be combined at the same time.

By encoding the show masters of all broadcast programming, similar to closed captioning, the audio narration can pass transparently through all existing broadcast systems and equipment.

The end users, the visually impaired and blind, will hear the associated audio description by one of several different means. Existing televisions can incorporate a decoder box to play the audio through the speakers of the television set. Alternatively, this signal can be sent directly to a head set worn by the visually impaired end user. The use of a headset allows those having normal sight to view the broadcasted programming in normal fashion without the audio description. It is anticipated that newly produced television sets will contain a decoder chip set which will take the line of video and produce the audio description for play directly through the speakers of the television. Of course, the signal can alternatively be sent to a head set worn by the visually impaired end user.

The decoder is essentially the reverse of the encoder (148) and reads the digital signal previously encoded onto the unused line of video and reprocesses the digital stream using the original code. The decoder also converts the digital signal to an analog signal using a D to A converter. The signal is then routed through either the dedicated decoder box, existing television speakers, or external set of headphones for final listening through composite audio connector usually having a one volt peak to peak signal similar to the original audio signal.

The invention can have additional applications to include digital lines for foreign languages. The blind are also excluded form a critically valuable service: the on-screen typed messages of the emergency broadcast system, which does not include audio. The encoder/decoder device thus becomes the emergency broadcast system for the blind and visually impaired. Also, television program guides are now in a typed format on-screen for sighted people. Visually impaired are currently excluded from those types of program listings.

Use of the present invention is beneficial as only the production facilities which create the master tapes would need to purchase the encoder (148) for implementation of the invention. With the increase of viewers, the producing company can acquire additional advertising dollars. Additionally, visually impaired-only audio advertising can be included in the narration audio signal so that products which are directed to the blind and visually impaired can be advertised directly to those consumers. This provides another potential source of income for the producer. Only the visually impaired and blind end users need purchase the decoding device or television, VCR, or other NTSC players which incorporate a decoding chip system. Thus, the cost of incorporating audio description is not born by those of normal sight nor of rebroadcasters, but rather those who derive benefit from the inclusion of audio description.

The process of the present invention enables the implementation of FCC MM Docket No. NN339 NTRM “Implementation of Video Description of Video Programming”, which requires narrative description for the visually impaired as described above. The process of the present invention also enables State and federal agencies to send emergency communications to the blind and visually impaired via the Emergency Alert System (EAS). Secondary alternative channels serve the purposes of delivering foreign language programming or radio stations can also be provided. Moreover, specialized on-line screen graphics, as well as visual cues and audio reinforcement for multiple applications, including the training of learning disabled individuals, is possible.

Although several embodiments have been described in detail for purpose of illustration, various modifications may be made without departing from the scope and spirit of the invention. Accordingly, the invention is not to be limited, except as by the appended claims.

1. A process for associating and delivering data with a video signal, comprising the steps of:
encoding a video source signal by inserting data in unused video bandwidth of the video source signal between the safe viewable area and the blanking portion;
transmitting the encoded video source signal;
decoding the encoded video source signal; and
visually displaying the data or audibly delivering the data to an end user.

2. The process of claim 1, wherein the encoding step includes the step of digitizing an analog data signal.

3. The process of claim 2, wherein the analog data signal comprises an audio signal.

4. The process of claim 3, wherein the audio signal comprises an audio narrative description of visual media associated with the video source signal.

5. The process of claim 2, including the step of compressing the digitized data.

6. The process of claim 2, including the step of transcoding the digitized data.

7. The process of claim 6, including the step of converting the data into television compatible RGB or VGA values.

8. The process of claim 1, wherein the decoding step includes the step of separating the inserted data from the video source signal.

9. The process of claim 8, wherein the decoding step includes the step of decompressing the inserted data.

10. The process of claim 8, wherein the decoding step includes the step of converting the data from a digital format into an analog signal.

11. The process of claim 10, wherein the analog signal comprises an audio signal that is delivered to audio speakers.

12. The process of claim 10, wherein the analog signal comprises an audio narrative description of visual media associated with the video source signal.

13. A process for transforming data for associating and delivering that data with video media, comprising the steps of:
transcoding analog or digital data to television compatible color value data.

14. The process of claim 13, wherein the color value data is comprised of multiple color pixels.

15. The process of claim 14, including the step of creating a pattern or grouping of pixels to represent data.

16. The process of claim 13, including the steps of digitizing an analog data signal, and compressing the digitized data before the transcoding step.

17. The process of claim 13, including the step of inserting the color value data into unused video lines of the video source signal other than the horizontal and vertical blanking intervals.

18. The process of claim 17, including the steps of:
transmitting the encoded video source signal;
decoding the encoded video source signal to separate the inserted data from the video source signal;
transcoding the inserted data into its original format;
decompressing the inserted data;
converting the inserted data from a digital format to an analog signal; and
visually displaying or audibly delivering the analog data signal to an end user.

19. The process of claim 18, wherein the analog data signal comprises an audio signal.

20. The process of claim 19, wherein the audio signal comprises an audio narrative description of visual media associated with the visual source signal.
